(19) United States
(12) Patent Application Publication
(10) Pub. No.: US 2004/0010409 A1
(43) Pub. Date: Jan. 15, 2004

(54) Voice recognition system, device, voice recognition method and voice recognition program

(76) Inventors: Hirohide Ushida, Nagoya-shi (JP); Hiroshi Nakajima, Kyoto-shi (JP); Hiroshi Daimoto, Yawata-shi (JP); Tsutomu Ishida, Osaka (JP)

Correspondence Address: Jonathan P. Osha, ROSENTHAL & OSHA L.L.P., Suite 2800, 1221 McKinney Street, Houston, TX, 77010, US

(21) Appl. No.: 10/405,066

(22) Filed: Apr. 1, 2003

(30) Foreign Application Priority Data
Apr. 1, 2002 (JP) 099103/2002

(51) Int. Cl. G10L 15/00

(52) U.S. Cl. 704/246

(57) ABSTRACT

There are provided a voice recognition system, a device, a voice recognition method, a voice recognition program and a computer-readable recording medium in which the audio recognition program is recorded in order to be able to implement at least one of audio recognition above vocabulary processed by one device and retention of appropriate vocabulary stored in one device. Audio data received by a client are recognized by an audio recognition engine and when its recognition result is rejected, the audio data is transmitted to a server and the recognition result in the server is transmitted to the client. The client updates a recognition dictionary according to the number of recognitions and integrates the recognition results in a result integration part. The client may be used instead of the server.

### BACKGOURD OF THE INVENTION

1. Field of the Invention

Conventionally, in order to perform audio recognition for large scale of vocabulary more than hundreds of thousands, a high-performance processor and a high-capacity memory have been needed.

2. Description of the Background Art

Therefore, it is difficult to perform audio recognition for large vocabulary at a PDA (Personal Digital Assistants) or a mobile phone terminal because costs of the terminal body is increased, which prevents them from being used in a mobile environment.

In order to solve the above problem, there are various kinds of prior arts.

As an example, the prior art consists of a server and a plurality of clients and vocabulary of default has been registered in the client. When a user wants the client to recognize vocabulary which is not in the default, the vocabulary is newly registered in the client.

According to the prior art, since the newly registered vocabulary is transmitted another client via the server, if the first user registered the vocabulary, it is not necessary for another user to register it.

However, there are two problems in the prior art. First, it is necessary for the first user to register the vocabulary.

Second, in a case used vocabulary is different depending on the users, the above prior art cannot be used.

### SUMMARY OF THE INVENTION

The present invention was made in view of the above problems and it is an object of the present invention to provide a voice recognition system, a device, an audio recognition method, an audio recognition program and a computer-readable recording medium in which the audio recognition program is recorded, thereby implementing at least one of audio recognition above vocabulary processed by one device and retention of appropriate vocabulary stored in one device.

The present invention relates to a voice recognition system, and a device, a voice recognition method, a voice recognition program and a computer-readable recording medium in which the audio recognition program is recorded, which are appropriately applied to the voice recognition system.

In order to achieve the object, a voice recognition system according to the present invention consists of a plurality of devices among which at least one or more devices comprises audio input means to which audio data is input, first audio recognition means for recognizing the audio data, first transmitting means for transmitting the audio data to another device in a predetermined case, receiving means for receiving a recognition result of the audio from the destination device of the audio data, and result integration means for outputting a recognition result of the audio according to at least one of a recognition result in the first audio recognition means and the recognition result received by the receiving means, and at least one or more devices among the plurality of devices comprises audio receiving means for receiving the audio data from the device to which the audio data was input, second audio recognition means for recognizing the audio data, and second transmitting means for transmitting a recognition result of the second audio recognition means to the destination device of the audio data.

Furthermore, according to a voice recognition system in the present invention, a predetermined case the first transmitting means transmits the audio data to another device is a case a degree of reliability in the recognition result by the first audio recognition means is not more than a predetermined threshold value.

Furthermore, according to a voice recognition system, at least one or more devices among the plurality of devices comprises storing means for storing vocabulary and updating means for updating the vocabulary stored in the storing means, and the updating means receives information referring to vocabulary from at least one or more other devices and updates the vocabulary stored in the storing means.

Furthermore, according to a voice recognition system in the present invention, at least one or more devices among the plurality of devices starts connection to at least one or more other devices on a condition that a predetermined event occurs.

Furthermore, a device according to the present invention is a device in a voice recognition system consisting of a plurality of devices, which comprises audio input means to which audio data is input, first audio recognition means for recognizing the audio data, first transmitting means for transmitting the audio data to another device in a predetermined case, receiving means for receiving a recognition result of the audio from the destination device of the audio data, and result integration means for outputting a recognition result of the audio according to at least one of a recognition result in the first audio recognition means and the recognition result received by the receiving means, and at least one or more second devices among the plurality of devices comprises audio receiving means for receiving the audio data from the device to which the audio data was input, second audio recognition means for recognizing the audio data, and second transmitting means for transmitting a recognition result of the second audio recognition means to the destination device of the audio data.

Furthermore, according to a device in the present invention, a predetermined case the first transmitting means transmits the audio data to another device is a case a degree of reliability in the recognition result by the first audio recognition means is not more than a predetermined threshold value.

Furthermore, a device according to the present invention comprises storing means for storing vocabulary and updating means for updating the vocabulary stored in the storing means, and the updating means receives information referring to vocabulary from at least one or more other devices and updates the vocabulary stored in the storing means.

Furthermore, a device according to the present invention starts connection to at least one or more other devices on a condition that a predetermined event occurs.

Furthermore, a device in a voice recognition system according to the present invention consists of a plurality of devices, from a first device which comprises audio input means to which audio data is input, first audio recognition means for recognizing the audio data, first transmitting means for transmitting the audio data to another device in a predetermined case, receiving means for receiving a recognition result of the audio from the destination device of the audio data, and result integration means for outputting a recognition result of the audio according to at least one of a recognition results in the first audio recognition means and the recognition result received by the receiving means; audio receiving means for receiving the audio data, second audio recognition means for recognizing the audio data, and second transmitting means for transmitting a recognition result of the second audio recognition means to the destination device of the audio data.

Furthermore, according to a device in the present invention, a predetermined case the first transmitting means transmits the audio data to another device is a case a degree of reliability in the recognition result by the first audio recognition means is not more than a predetermined threshold value.

Furthermore, a method of recognizing audio according to the present invention in a device in a voice recognition system consisting of a plurality of devices comprises an input step of inputting audio data, a device to which the audio data is input comprises steps of a first audio recognition step of recognizing the audio data, a first transmitting step of transmitting the audio data to another device in a predetermined case, a receiving step of receiving a recognition result of the audio from the destination device of the audio data, and a result integration step of outputting the recognition result of the audio according to at least one of the recognition results in the first audio recognition step and the recognition result received in the receiving step, and a device among the plurality of devices comprises an audio receiving step of receiving the audio data from the device to which the audio data is input, a second audio recognition step of recognizing the audio data, and a second transmitting step of transmitting the recognition result of the second audio recognition step to the designation device of the audio data.

Furthermore, according to a method of recognizing audio in the present invention, a predetermined case the audio data is transmitted to another device at the first transmitting step is a case a degree of reliability in the recognition result by the first audio recognition step is not more than a predetermined threshold value.

Furthermore, according to a method of recognizing audio in the present invention, a device among the plurality of devices comprises storing step of storing vocabulary and updating step of updating the stored vocabulary, and the updating step receives information referring to vocabulary from at least one or more other devices and updates the stored vocabulary.

Furthermore, according to a method of recognizing audio in the present invention, at least one or more devices among the plurality of devices starts connection to at least one or more other devices on a condition that a predetermined event occurs.

Furthermore, according to a voice recognition program in the present invention, a device in a voice recognition system consisting of a plurality of devices functions as audio inputting means to which audio data is input, first audio recognition means for recognizing the audio data, first transmitting means for transmitting the audio data to another device in a predetermined case, receiving means for receiving a recognition result of the audio from the destination device of the audio data, and result integration means for outputting the recognition result of the audio according to at least one of the recognition results in the first audio recognition means and the recognition result received by the receiving means.

Furthermore, according to a voice recognition program in the present invention, a predetermined case the first transmitting means transmits the audio data to another device is a case a degree of reliability in the recognition result by the first audio recognition means is not more than a predetermined threshold value.

Furthermore, a voice recognition program according to the present invention comprises a step of functioning as updating means for updating vocabulary stored in storing means for storing the vocabulary and the updating means receives information referring to vocabulary from at least one or more other devices and updates the vocabulary stored in the storing means.

Furthermore, according a voice recognition program in the present invention, a connection between devices starts on a condition that a predetermined event occurs.

Furthermore, according to a voice recognition program in the present invention, in a device in a voice recognition system consists of a plurality of devices whose first device comprises audio input means to which audio data is input, first audio recognition means for recognizing the audio data, first transmitting means for transmitting the audio data to another device in a predetermined case, receiving means for receiving a recognition result of the audio from the destination device of the audio data, and result integration means for outputting a recognition result of the audio according to at least one of a recognition results in the first audio recognition means and the recognition result received by the receiving means, and a device in the audio recognition system which receives the audio data from the first device functions as audio receiving means for receiving the audio data, second audio recognition means for recognizing the audio data, and second transmitting means for transmitting a recognition result by the second audio recognition means to the destination device of the audio data.

Furthermore, according to a voice recognition program in the present invention, a predetermined case the first transmitting means transmits the audio data to another device is a case a degree of reliability in the recognition result by the first audio recognition means is not more than a predetermined threshold value.

Thus, according to the present invention, even if the vocabulary is beyond the vocabulary which can be recognized by one device, the audio recognition can be performed. In addition, it is not necessary for the user to register the vocabulary. Furthermore, even if the registered vocabulary is different depending upon the user, it can be used.

Still further, according to the present invention, the audio recognition can be sufficiently performed even at a terminal which only has performance of a mobile phone or the like.

Here, according to the present invention, the audio data comprises not only audio data as oscillation of air, but also analog data of an electric signal or digital data of an electric signal.

In addition, according to the present invention, the recognition of the audio data means that the input audio data corresponds to one or more vocabularies. For example, a piece of input audio data corresponds to vocabulary and a degree of reliability for the vocabulary is added to the vocabulary.

Here, the degree of reliability is a value of probability that the vocabulary corresponding to the audio data coincides with the input audio data.

Furthermore, according to the present invention, the vocabulary comprises not only a word but also a sentence, a part of a sentence, an imitation sound or a sound generated by a human being.

Still further, the event according to the present invention means an event which triggers the next operation and comprises an incident, an operation, a time condition, a place condition or the like.

### BRIEF DESCRIPTION OF THE DRAWINGS

FIG. 1 is a whole structure diagram showing a voice recognition system according to a first embodiment of the present invention.

FIG. 2 is an internal block diagram in case a mobile phone is used as a client 101 shown in FIG. 1.

FIG. 3 is an internal block diagram in case a PDA is used as a client 101 shown in FIG. 1.

FIG. 4 is a schematic view showing a recognition result outputted by an audio recognition engine 104 shown in FIG. 1.

FIG. 5 is a schematic view showing the number of recognitions every vocabulary stored in a recognition dictionary 103 which is counted in a dictionary control part 106 shown in FIG. 1.

FIG. 6 is an internal block diagram of a server 111 shown in FIG. 1.

FIG. 7 is a flowchart showing operations of the voice recognition system shown in FIG. 1.

FIG. 8 is a schematic view showing an update operation of the recognition dictionary 103 by the dictionary control part 106 shown in FIG. 1.

FIG. 9 is a whole structure diagram showing a voice recognition system according to a second embodiment of the present invention.

FIG. 10 is a flowchart showing operations of the voice recognition system shown in FIG. 9.

### DESCRIPTION OF THE PREFERRED EMBODIMENTS

Hereinafter, preferred embodiments of the present invention will be schematically described in detail with reference to the drawings. The scope of the present invention is not limited to a dimension, a material, a configuration and its relative configuration of a component described in the embodiments except that particularly specific description is made.

In addition, in the following drawings, the same reference numerals are allotted to the same components as those described in the previous drawing. Furthermore, description of a voice recognition system according to each embodiment of the present invention to be made hereinafter combines with description of a device, a voice recognition method and a voice recognition program according to each embodiment of the present invention.

[First Embodiment of a Voice Recognition System]

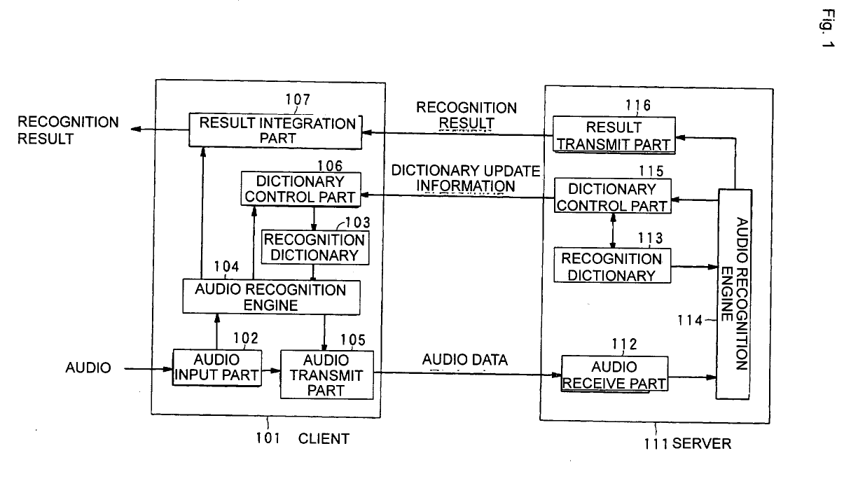

First, description will be made of a voice recognition system according to a first embodiment of the present invention. FIG. 1 shows a whole structure of the voice recognition system according to the first embodiment of the present invention. The voice recognition system according to this embodiment comprises a client 101 and a server 111 which are connected to each other by network.

According to the voice recognition system of the first embodiment of the present invention, as shown in FIG. 1, the number of the client 101 and the server 111 is not limited to one and the number of the client and that of the server may be any plural number, respectively.

Reference numeral 101 designates the client. The client 101 is a terminal owned by a user and has a function of communicating with a server 111.

As the client 101, for example, there are a personal computer, a PDA, a mobile phone, a car navigation system, a mobile personal computer or the like. However, the client according to the present invention is not limited to those and other kind of clients can be used.

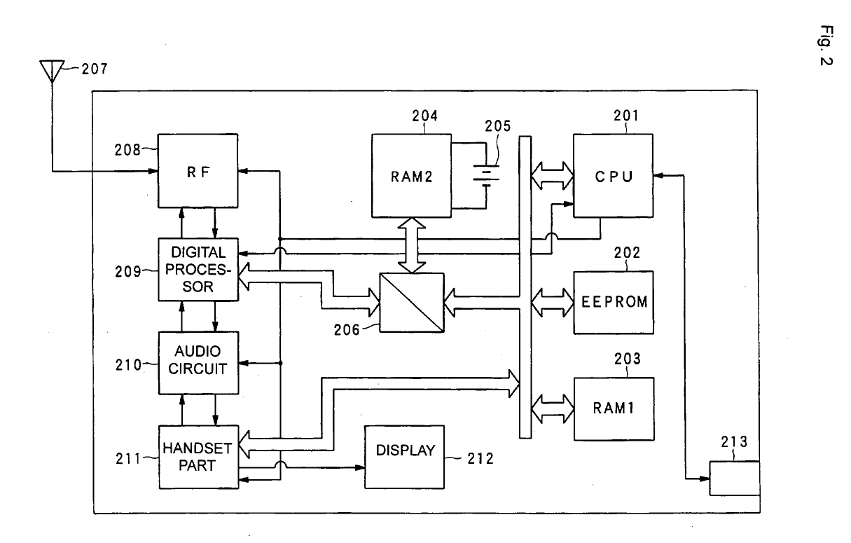

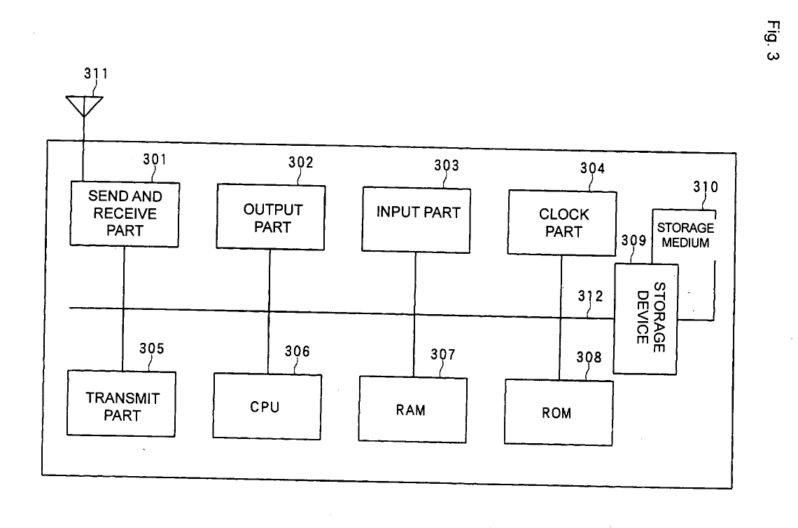

Internal structures when a mobile phone is used as the client 101 and when a PDA is used as the client 101 will be described with reference to FIGS. 2 and 3 respectively.

FIG. 2 is an internal block diagram when the mobile phone is used as the client 101 shown FIG. 1 and FIG. 3 is an internal block diagram when the PDA is used as the client 101 shown in FIG. 1.

The mobile phone shown in FIG. 2 communicates with a predetermined fixed station through a digital wireless telephone line to talk with others.

Referring to FIG. 2, a CPU 201 is a system controller comprising a microcomputer which controls an operation of each circuit and part shown in FIG. 2.

The mobile phone is connected to an antenna 207. The antenna 207 supplies a received signal of a predetermined frequency band (800 MHz, for example) to a radio frequency circuit 208 (referred to as a RF circuit hereinafter) in which it is demodulated and the demodulated signal is supplied to a digital processor 209.

The digital processor 209 is called a digital signal processor (DSP) which performs various digital processing such as digital demodulation for the signal and then, converts it to an analog audio signal.

The digital processing in the digital processor 209 includes processing for extracting a required output of a slot from a time-division multiplexed signal and processing for waveform equalizing the digital-demodulated signal with an FIR filter.

The converted analog audio signal is supplied to an audio circuit 210 in which analog audio processing such as amplification is performed.

Then, the audio signal output from the audio circuit 210 is sent to a handset part 211 and audio is output by a speaker (not shown) which is built in the handset part 211.

In addition, audio data acquired by a microphone (not shown) which is built in the handset part 211 is transmitted to the audio circuit 210 in which analog audio processing such as amplification is performed and then, transmitted to the digital processor 209.

Then, it is converted to a digital audio signal in the digital processor 209 and then, processing such as digital modulation for transmission is performed.

The processed digital audio signal is transmitted to the RF circuit 208 and modulated to a predetermined frequency band (800 MHz, for example) for transmission. Then, the modulated wave is transmitted from the antenna 207.

Furthermore, a display 212 such as a liquid crystal display or the like is connected to the handset part 211 according to this embodiment, on which information comprising various characters and/or images is displayed.

For example, the display 212 is controlled by data transmitted from the CPU 201 through a bus line to display a picture image of an accessed homepage, information referring to a telephone call such as a transmitted dial numbers or operations at the time of upgrading in some cases.

In addition, keys (not shown) are mounted to the handset part 211, through which an input operation of dial numbers or the like is performed.

Each of the circuits 208 to 211 is controlled by the CPU 201. Thus, a control signal is transmitted from the CPU 201 to each of the circuits 208 to 211 through a control line.

Furthermore, the CPU 201 is connected to an EEPROM 202, a first RAM 203 and a second RAM 204 through a bus line.

In this case, the EEPROM 202 is a read-only memory in which an operation program of the mobile phone 102 is previously stored but a part of data can be rewritten by the CPU 201.

Therefore, the program stored in the EEPROM 202 is a program according to the present invention and the EEPROM 202 itself is a computer-readable recording medium which recorded the program according to the present invention.

Thus, functions of audio input means, first voice recognition means, first transmitting means, receiving means, result integration means, storing means and updating means described in claims of the present invention are implemented by the CPU 201 shown in FIG. 2 alone, or such that it collaborates with other parts shown in FIG. 2 or the program stored in the EEPROM 202.

In addition, a first RAM 203 is a memory for temporarily storing data which are rewritten by the EEPROM 202.

Furthermore, a second RAM 204 is a memory in which control data of the digital processor 209 are stored.

In this case, a bus line connected to the second RAM 204 can be switched between the CPU 201 and the digital processor 209 through a bus switch 206.

Only when the operation program of the mobile phone is corrected, the second RAM 204 is switched to the CPU 201 by the bus switch 206.

Therefore, in other conditions, the first RAM 203 is connected to the digital processor 209.

In addition, a backup battery 205 for preventing from losing stored data is connected to the second RAM 204.

Meanwhile, according to this embodiment of the present invention, data received from the outside can be input to the CPU.

In other words, reference numeral 213 in FIG. 2 designates a connector for connecting to the outside and data acquired by the connector 213 can be transmitted to the CPU 201.

Next, description will be made of a case the PDA is used as the client 101 shown in FIG. 1.

FIG. 3 is an internal block diagram showing the PDA (Personal Digital Assistants) used as the client 101 shown in FIG. 1.

The PDA comprises a send and receive part 301, an output part 302, an input part 303, a clock part 304, a transmit part 305, a CPU 306, a RAM 307, a ROM 308, a storage device 309 on which a storage medium 310 is mounted or the like and each of the components device is connected through a bus 312 to each other.

The CPU (Central Processing Unit) 306 stores a system program stored in the storage medium 310 in the storage device 309 and an application program designated from various application programs corresponding to the system program, in a program storage region in the RAM 307.

Then, the CPU 306 stores various designations or input data input through the send and receive part 301, the input part 303, the clock part 304 and outer base station in the RAM 307 and performs various processes corresponding to the input designation or data according to the application program stored in the storage medium 310.

Then, the CPU 306 stores the processed result in the RAM 307. Further, the CPU 306 reads data to be transmitted from the RAM 307 and outputs it to the send and receive part 301.

The send and receive part 301 can be constituted by a PHS unit (Personal Handy-phone System Unit), for example.

The send and receive part 301 transmits data (search output request data or the like) input from the CPU 306 through an antenna 311 to an outside base station in form of an electric wave based on a predetermined communication protocol.

The output part 302 is provided with a display screen which implements LCD display or CRT display and displays various input data from the CPU 306 thereon.

The input part 303 comprises a display screen for input by various keys or a pen (in this cease, the display screen is mostly the display screen in the output part 302) and it is an input device for inputting data referring to a schedule or the like, various kinds of search instructions and various kinds of settings for PDA through a key-input or a pen-input (including recognition of handwritten characters by a pen). Thus, a signal input by the keys or the pen is output to the CPU 306.

In addition, according to this embodiment of the present invention, the input part 303 includes an audio data input device such as a microphone for inputting the audio data.

The clock part 304 has a clocking function. Information referring to clocked time is displayed in the output part 302 or when the CPU 306 inputs or stores data (referring to the schedule, for example) comprising time information, the information referring to time is input from the clock part 304 to the CPU 306 and the CPU 306 operates according to the time information.

The transmit part 305 is a unit for performing wireless or wired data transmission at short distance.

The RAM (Random Access Memory) 307 comprises a storage region for temporarily storing various kinds of programs or data which are processed by the CPU 306. In addition, the RAM 307 reads stored various kinds of programs or data.

In the RAM 307, an input instruction or input data from the input part 303, various data sent from the outside through the send and receive part 301, a result processed by the CPU 306 according to a program code read from the storage medium 310 and the like are temporarily stored.

The ROM (Read Only Memory) 308 is a read-only memory for reading data stored according to the instruction of the CPU 306.

The storage device 309 comprises the storage medium 310 in which a programs or, data and the like are stored and the storage medium 310 comprises a magnetic or optical storage medium or a semiconductor memory. In addition, the storage medium 310 may be fixed in the storage device 309 or detachable from it.

The storage medium 310 stores a system program, various kinds of application programs corresponding to the system program, data (comprising schedule data) processed by a display process, a transmit process, an input process and other process programs or the like.

In addition, the programs, data and the like to be stored in the storage medium 310 may be received from another device connected through a transmission line or the like. Furthermore, a storage device comprising the above storage medium may be provided in another device connected through the transmission line such that the program or data stored in the storage medium may be used through the transmission line.

As described above, the program stored in the ROM 308 or the storage medium 310 is a program according to the present invention and the ROM 308 or the storage medium 310 itself is the computer-readable storage medium which stores the program according to the present invention.

Accordingly, functions of audio input means, first voice recognition means, first transmitting means, receiving means, result integration means, storing means and updating means described in claims of the present invention are implemented by the CPU 301 shown in FIG. 3 alone or such that is collaborates with other parts shown in FIG. 3 or the program stored in the ROM 308 or the storage medium 310.

The client 101 comprising a mobile phone, a PDA or the like recognizes audio received from a user. In addition, the client 101 transmits audio data to the server 111 and receives a recognition result from the server 111 in a predetermined case.

Then, return to the description of the client 101 shown in FIG. 1. The client 101 comprises an audio input part 102. The audio input part 102 receives audio data from the user.

In addition, the audio input part 102 outputs the audio data to an audio recognition engine 104 and an audio transmit part 105.

Furthermore, the audio input part 102 converts analog input audio to digital audio data.

Then, the audio recognition engine 104 receives the audio data from the audio input part 102. In addition, the audio recognition engine 104 loads vocabulary from a recognition dictionary 103.

The audio recognition engine 104 recognizes the loaded data in the recognition dictionary and the audio data input from the audio input part 102. This recognition result is derived as a degree of reliability for each vocabulary.

Then, description will be made of processing procedures of audio recognition in general in the audio recognition engine 104 according to this embodiment of the present invention.

The audio recognition process in the audio recognition engine 104 comprises an audio analysis process and a search process.

1. Audio Analysis Process

The audio analysis process is a process for finding a feature amount used for the audio recognition from an audio waveform. As the feature amount, cepstrum is used in general. The cepstrum is defined as inverse Fourier transform of logarithm of short-time amplitude spectrum of the audio waveform.

2. Search Process

The search process is a process for finding category (a word or a word string) of audio data which is most close to the feature amount. In the general search process, two kinds of statistic models such as an acoustic model and a linguistic model are used.

The acoustic model designates a feature of a human voice statistically and a model of each phoneme (a vowel such as [a] or [i] and a consonant such as [k] or [t]) based on previously collected acoustic data is to be previously found by a calculation.

As a general method for describing the acoustic model, Hidden Markov Model is used.

The linguistic model defines audio-recognizable vocabulary space, that is, imposes restriction to an arrangement of the acoustic model. For example, it defines how the word “mountain” is designated by a phoneme range or how a certain sentence is designated by a word string.

As the linguistic model, N-gram is used in general. In the search process, the feature amount extracted by the audio analysis is referred to the acoustic model and the linguistic model. In the reference, the closest word in view of a probability is derived using probabilistic process based on Bayes' rule.

The result of the reference is represented by a probability that which word or word string is similar and final probability is provided by integrating the two models.

The Hidden Markov Model, N-gram, Bayes' rule are described in detail in the following document; “Audio Language Processing” written by Kenji Kita, Tetsu Nakamura and Masaaki Nagata, Morikita Publications.

In addition, the audio recognition engine 104 outputs the recognition result of the audio data to the audio transmit part 105, a dictionary control part 106 and a result integration part 107.

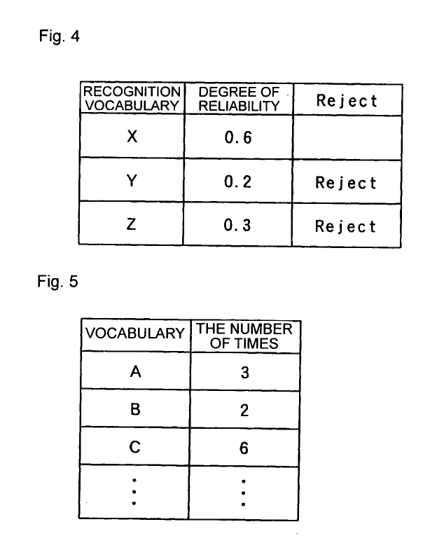

Here, an example of the recognition result output from the audio recognition engine 104 will be described with reference to FIG. 4. FIG. 4 is a schematic view showing the recognition result output from the audio recognition engine 104 shown in FIG. 1.

According to the example of the recognition result shown in FIG. 4, as the recognition vocabulary recognized by the audio recognition engine 104 for the audio data input to the audio recognition engine 104, “X”, “Y” and “Z” are output. It is needless to say that the recognition vocabulary output from the audio recognition engine 104 according to this embodiment of the present invention are not limited to “X”, “Y” and “Z” and the audio recognition engine 104 outputs vocabulary other than those and the more number than those.

The audio recognition engine 104 derives a degree of reliability for the respective recognition vocabulary. As a method of deriving the degree of reliability, well-known technique can be used.

According to the example shown in FIG. 4, the degree of reliability is set at 0.6 for the recognition vocabulary “X”, 0.2 for the recognition vocabulary “Y” and 0.3 for the recognition vocabulary “Z”.

Furthermore, the audio recognition engine rejects the vocabulary except for the vocabulary which is more than a predetermined degree of reliability (threshold value). According to the example shown in FIG. 4, the threshold value of the degree of reliability is set at 0.5, for example and the vocabulary except for “X” is rejected.

Thus, when the degree of reliability of the recognition result is lower than the threshold value, the audio recognition engine 104 outputs information that the recognition result is rejected to the audio transmit part 105, the dictionary control part 106 and the result integration part 107. As described above, the audio recognition engine 104 recognizes the audio data according to the vocabulary stored in the recognition dictionary.

Then, the vocabulary to be registered is output from the dictionary control part 106 to the recognition dictionary 103 shown in FIG. 1. A user or a designer may previously register the vocabulary in the recognition dictionary 103. The recognition dictionary 103 functions as storing means for storing vocabulary and another recognition dictionary other than the recognition dictionary 103 is the same.

The recognition dictionary 103 outputs the vocabulary to the audio recognition engine 104. In addition, the recognition dictionary 103 stores the vocabulary.

Then, the audio transmit pat 105 receives the audio data from the audio input part 102. In addition, the audio transmit part 105 receives the recognition result from the audio recognition engine 104.

Then, the audio transmit part 105 transmits the audio data to the server 111. More specifically, in case the audio transit part 105 receives information that the recognition result for the audio data is all rejected according to the recognition result from the audio recognition engine 104, it transmits the audio data received from the audio input part 102 to the server 111.

As a method of determining a destination server, there is a method of transmitting the data to a server which exists close to a source client in view of a physical distance. That is, the server to communicate with may be determined according to information referring to a distance between the devices.

The information referring to the distance can comprise positional information of the base station with which the client communicates or information obtained by GPS (Global Positioning Systems).

Then, the dictionary 106 receives dictionary update information from the server 111 and updates the vocabulary of the recognition dictionary 103. Therefore, the dictionary control part 106 functions as updating means. This updating operation will be described later.

The number of times the server 111 has recognized the audio data received from the client 101 is recorded for each vocabulary in the dictionary update information. In addition, the dictionary control part 106 receives the recognition result from the audio recognition engine 104.

Furthermore, the dictionary control part 106 outputs vocabulary to the recognition dictionary 103. In addition, the dictionary control part 106 counts the number of recognitions each vocabulary stored in the recognition dictionary 103 according to the recognition result received from the audio recognition engine 104.

Here, description will be made of the number of recognitions each vocabulary stored in the recognition dictionary 103 which is counted in the dictionary control part 106 with reference to FIG. 5. FIG. 5 is a schematic view of the number of recognitions for each vocabulary stored in the recognition dictionary 103 which is counted in the dictionary control part 106 shown in FIG. 1.

As shown in FIG. 5, information referring to the number of recognitions is stored in each vocabulary stored in the recognition dictionary 103. More specifically, according to the example shown in FIG. 5, the number of recognitions for vocabulary “A” is three, the number of recognitions for vocabulary “B” is two and the number of recognitions for vocabulary “C” is six.

Meanwhile, the dictionary control part 106 sorts all vocabulary stored in the recognition dictionary 103 by the number of recognitions according to the dictionary update information (that is, the time of recognitions for each vocabulary in the server 111) received from the server 111 and the number of recognitions for each vocabulary in the client 101. This sorting operation will be described later.

Then, the dictionary control part 106 registers the vocabulary in the recognition dictionary 103 as many as possible in order of the large number of recognitions.

Then, the result integration part 107 receives the recognition result of the client 101 from the audio recognition engine 104.

Furthermore, the result integration part 107 receives the recognition result of the server 111 from the server 111. Therefore, the result integration part 107 functions as receiving means of the recognition result from the server 111.

Then, the result integration part 107 outputs an integrated recognition result. This output from the result integration part 107 is used for confirmation by audio or application.

More specifically, the result integration part 107 integrates the recognition results of the client 101 and the server 111 and employs the recognition result of the server 111 when the recognition result of the client 101 is rejected.

In addition, the result integration part 107 employs the recognition result of the client 101 when the recognition result of the client 101 is not rejected.

Furthermore, if there are plurality of recognition results which are not rejected, the result integration part 107 may output the recognition result which has the highest degree of reliability.

Then, the server 111 receives the audio data from the client 101 and recognizes it.

Then, the server 111 transmits the vocabulary having many times of recognitions to the client 101. Hereinafter, the structure and operations of the server 111 will be further described.

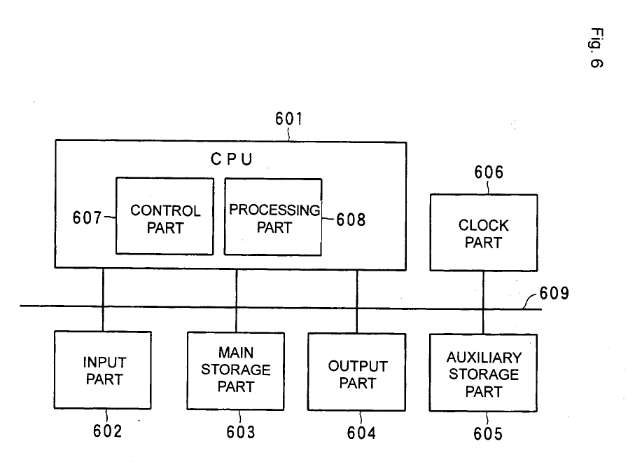

The internal structure of the server 111 shown in FIG. 1 will be described with reference to FIG. 6. FIG. 6 is an internal block diagram of the server 111 shown in FIG. 1.

As shown in FIG. 6, the server 111 comprises a CPU (Central Processing Unit) 601, an input part 602, a main storage part 603, an output part 604, an auxiliary storage part 605 and a clock part 606.

The CPU 601 is also known as a processor which comprises a control part 607 for controlling an operation of each part in the system by sending an instruction to it and a processing part 608 for processing digital data which is a central portion of the server 111.

Here, the CPU 601 functions as audio receiving means, second audio recognition means and second transmitting means in the claims of this specification by itself, or with another part shown in FIG. 6 or by collaborating with a program stored in the main storage part 603 or the auxiliary storage part 605.

The control part 607 reads input data from the input part 602 or previously provided procedure (a program or a software, for example) into the main storage part 603 according to clock timing generated by the clock part 606 and sends an instruction to the processing part 608 to perform processing according to the read contents.

The result of the processing is transmitted to the internal devices such as the main storage part 603, the output part 604 and the auxiliary part 605 and the outer device according to the control of the control part 607.

The input part 602 is a part for inputting various kinds of data, which comprises a keyboard, a mouse, a pointing device, a touch-sensitive panel, a mouse pad, a CCD camera, a card reader, a paper tape reader, a magnetic tape part or the like.

The main storage part 603 is also known as a memory which means addressable storage space used for executing an instruction in the processing part and an internal storage part.

The main storage part 603 is mainly constituted by a semiconductor storage element and stores and holds an input program or data and reads the stored data into a register, for example according to the instruction of the control part 607.

In addition, as the semiconductor storage element constituting the main storage part 603, there are a RAM (Random Access Memory), a ROM (Read Only Memory) and the like.

The output part 604 is a part for outputting a processed result of the processing part 608 and corresponds to a CRT, a display such as plasma display panel, a liquid crystal display or the like, a printing part such as a printer, audio output part and the like.

Furthermore, the auxiliary storage part 605 is a part for compensating a storage capacity of the main storage part 603 and as a medium used for this, in addition to CD-ROM and hard disc, there can be used information-writable write-once type of CD-R and DVD-R, a phase-change recording type of CD-RW, DVD-RAM, DVD+RW and PD, a magnetooptical storing type of recording medium, a magnet recording type of recording medium, a removal HDD type of recording medium or a flash memory type of recording medium.

Here, the above parts are connected by a bus 609 to each other.

In addition, if there is an unnecessary part in the server according to this embodiment shown in FIG. 6, it can be appropriately removed. For example, the display constituting the output part 604 is not necessary in some cases. In this case, the output part 604 is sometimes not necessary in the server according to this embodiment.

Furthermore, the number of the main storage part 603 and the auxiliary storage part 605 is not limited to one and it may be any number. As the number of the main storage part 603 and the auxiliary storage part 605 is increased, fault tolerance of the server is improved.

Furthermore, various kinds of programs according to the present invention are stored (recorded) in at least either one of the main storage part 603 and the auxiliary storage part 605.

Therefore, at least either one of the main storage part 603 or the auxiliary storage part 605 can correspond to the computer-readable recording medium which stored the programs according to the present invention.

Then, operations of the server 111 shown in FIG. 1 will be described. An audio receiving part 112 receives audio data from the client 101. In addition, the audio receiving part 112 outputs the audio data received from the client 101 to an audio recognition engine 114.

Then, a recognition dictionary 113 acquires vocabulary to be registered from a dictionary control part 115. A user or designer may previously register vocabulary in the recognition dictionary 113.

The recognition dictionary 113 outputs the vocabulary to the audio recognition engine 114. In addition, the recognition dictionary 113 stores the vocabulary.

Then, the audio recognition engine 114 loads the vocabulary from the recognition dictionary 113. In addition, the audio recognition engine 114 receives the audio data from the audio receiving part 112.

Furthermore, the audio recognition engine 114 recognizes the audio data according to the vocabulary and outputs the audio data recognized result to a dictionary control part 115 and a result transmit part 116. A structure and operations of the audio recognition engine 114 may be the same as or different from those of the audio recognition engine 104.

An outline of the audio recognized result by the audio recognition engine 114 is the same as the recognized result shown in FIG. 4.

Then, the dictionary control part 115 acquires the recognition result from the audio recognition engine 114. In addition, the dictionary control part 115 outputs dictionary update information to the client 101.

More specifically, according to the recognition result received from the audio recognition engine 114, the dictionary control part 115 counts the number of recognitions for each vocabulary stored in the recognition dictionary 113 in the server 111 and updates the number of recognitions for each vocabulary stored in the recognition dictionary 113.

The counted result is stored in the recognition dictionary 113 as shown by the schematic view of the number of recognitions shown in FIG. 5, for example.

Here, the number of recognitions for each vocabulary in the server 111 may be counted every vocabulary and every client 101.

Furthermore, the client may be divided into predetermined groups and the number of recognitions for each vocabulary in the server 111 may be counted every vocabulary and this every predetermined group.

Still further, the number of recognitions for each vocabulary in the server 111 may be a sum of the number of recognitions for each vocabulary for all clients connected to the server 111.

Furthermore, the dictionary control part 115 transmits the number of recognitions for each vocabulary in the recognition dictionary 113 to the client 101 as dictionary update information.

Here, the dictionary update information to be transmitted from the dictionary control part 115 to the client 101 may comprise a corresponding relation between all vocabulary and the number of recognitions stored in the recognition dictionary 113, for example or may comprise a corresponding relation between each vocabulary having the number of recognitions which is more than a fixed value and the number of recognitions.

In addition, as the timing of the output of the dictionary update information from the dictionary control part 115 to the client 101, various kinds of timing are employed, for example, the information may be output at regular time intervals or it may be output after the number of recognitions in the server 111 reaches the predetermined number or when the user presses an update button in the client 101.

Then, the result transmit part 116 acquires the recognition result in the server 111 from the audio recognition engine 114 and outputs it to the client 101.

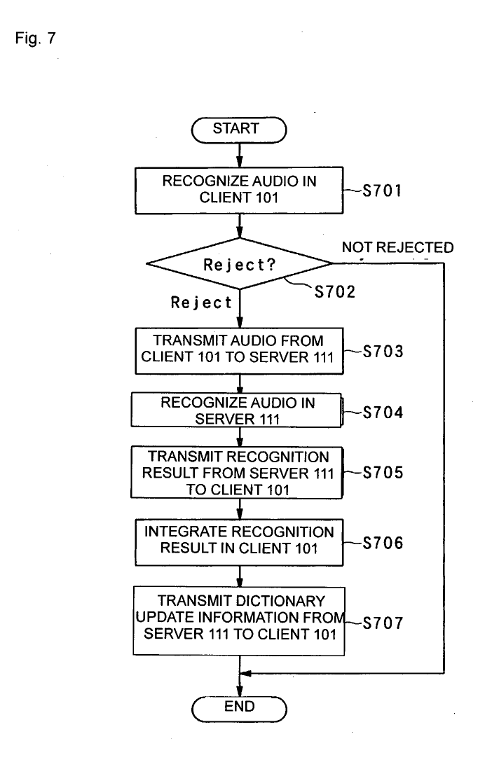

Then, operations of the audio recognition system shown in FIG. 1 will be described further in detail with reference to FIG. 7. FIG. 7 is a flowchart of the operations of the audio recognition system shown in FIG. 1.

First, at step S701, the client 101 recognizes audio from the user and counts the number of recognitions for each vocabulary.

Then, at step S702, when the audio recognition result of the vocabulary is not rejected in the client 101, this is regarded as the recognition result and the operation ends.

When the recognition result is rejected in the client 101, the operation proceeds to step S703.

At step S703, the audio data is transmitted from the client 101 to the server. The connection between the client and the server may be either one of the following 1 and 2.

1. They are always connected.

2. The connection starts at the time of particular event and/or ends at the time of the following particular events. The particular events may be combined and used.

(Particular Events)

(1) When the recognition result is rejected, the connection starts and it ends when the recognition result is acquired from the server. In other words, the fact that the audio is not recognized at the client can be the particular event.

(2) When the audio data is input from the user, the connection starts and when the recognition result is acquired from the server, the connection ends. In other words, the fact that the audio data is input to the client can be the particular event.

(3) When the user starts up any device, the connection starts and when the user ends the operation of the device, the connection ends. The device is an ignition key of a car, for example. In other words, the fact that a signal is input from the outside to the client can be the particular event.

(4) The client controls the start and end of the connection according to the time and place to be used. For example, the user sets the time and region used frequently or the client gets them automatically. Then, the vocabulary at the time and region used frequently is stored in the client and the audio recognition is performed in the client. When the client is out of position from either one of the time or region frequently used, the server is connected and the server performs the audio recognition. That is, the fact that the client is used out of a predetermined time or out of a predetermined region can be the particular event.

The flowchart shown in FIG. 7 will be described again. At step S704, the server 111 performs the audio recognition. Then, the server 111 counts the number of recognitions every vocabulary.

Here, as described above, the number of recognitions for each vocabulary in the server 111 may be counted every vocabulary and every client 101.

Furthermore, the client may be divided into predetermined groups and the number of recognitions for each vocabulary in the server 111 may be counted every vocabulary and every this predetermined group.

Still further, the number of recognitions for each vocabulary in the server 111 may be a sum of the number of recognitions for each vocabulary for all clients connected to the server 111.

Then, at step S705, the server 111 transmits the recognition result to the client 101.

Then, at step S706, the client 101 integrates the recognition result of the client 101 and the server 111.

Then, at step S707, the server 111 transmits the dictionary update information to the client 101 at regular time intervals or every number of recognition of the audio data.

As described above, however, according to this embodiment of the present invention, as the timing of the transmission of the dictionary update information from the server 111 to the client 101, there is a case the user updates by oneself by pressing an update button in the client 101, for example.

Thus, when the client 101 receives the dictionary update information from the server 111, the recognition dictionary 103 is updated in the dictionary control part 106.

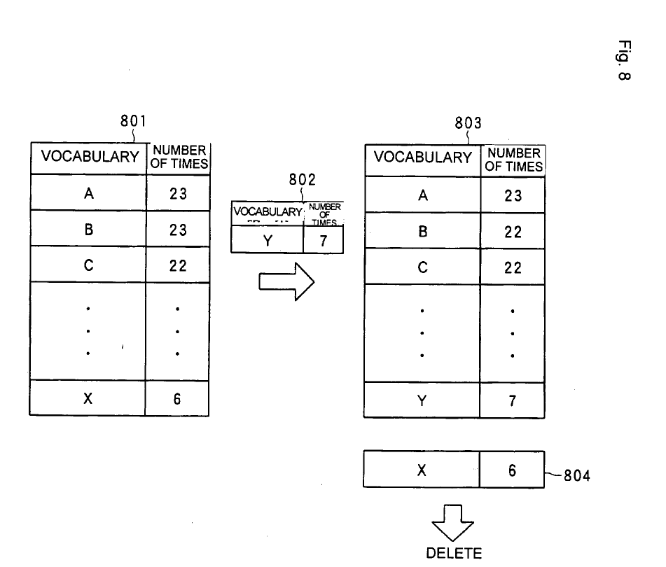

Here, the update of the recognition dictionary 103 by the dictionary control part 106 will be described with reference to FIG. 8. FIG. 8 is a schematic diagram showing the update operation of the recognition dictionary 103 by the dictionary control part 106 shown in FIG. 1.

First, it is assumed that a table 801 is stored in the recognition dictionary 103 at an initial condition. In the table 801, the number of recognitions is set every vocabulary and the least number of recognitions is six of the vocabulary “X”, for example.

Here, the vocabulary from “A” to “X” is placed in order according to the number of recognitions in the table 801. The vocabulary “X” is in the lowest order. When the number of recognitions is the same, the order may be the same or differentiated according to the order of input, for example. In the latter case, the number of the final order corresponds to the number of vocabulary stored in the recognition dictionary 103.

Then, it is assumed that the dictionary control part 106 receives a table 802 from a dictionary control part 205 as the dictionary update information. The table 802 stores the data that the number of recognitions of the vocabulary “Y” is seven, for example.

Thus, in the information referring to the vocabulary which the dictionary control part 106 according to this embodiment receives from the dictionary control part 115 of the server 111, the vocabulary and the number of recognitions each vocabulary can be included.

Thus, the dictionary control part 106 receives the table 802 as the dictionary update information, sorts the table 801 stored in the recognition dictionary 103 according to the number of recognitions of the vocabulary “Y” and updates by deleting the vocabulary other than vocabulary having the predetermined order, so that a table 803 is generated.

In the table 803, a part corresponding to the vocabulary “Y” is added and a part 804 corresponding to the vocabulary “X” existed in the table at the initial condition is deleted because it is out of the predetermined order of the table 803.

In other words, vocabulary stored in the recognition dictionary 103 is updated by the dictionary control part 106.

However, the updating method of the vocabulary stored in the recognition dictionary 103 by the dictionary control part 106 according to this embodiment of the present invention is not limited to the above method.

More specifically, there can be a method in which the dictionary control part 106 does not delete the vocabulary which is out of the predetermined order but does not use that vocabulary.

In addition, there can be a method in which the dictionary control part 106 deletes the vocabulary when limit of a memory capacity of the recognition dictionary 103 is exceeded in stead of using the predetermined order as the deleting condition.

As described above, according to the voice recognition system of the first embodiment of the present invention, even when the processing capability for voice recognition in the client 101 is not so high, since audio can be recognized in the server 111 connected to the client 101, performance of the voice recognition can be improved.

Furthermore, since the number of recognitions of the vocabulary is counted and the client 101 updates the recognition dictionary 103 in the client 101 according to the counted result, even if the user of the client 101 does not update the recognition dictionary 103 manually, the appropriate recognition dictionary 103 can be provided.

[Second Embodiment of a Voice Recognition System]

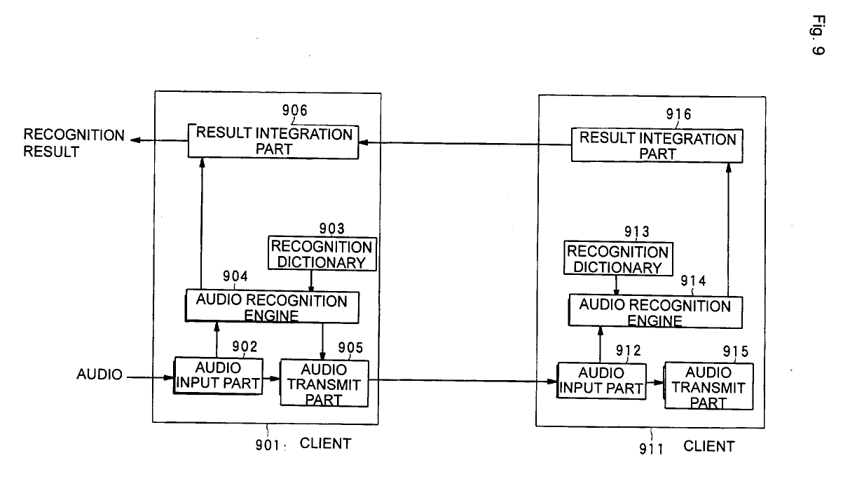

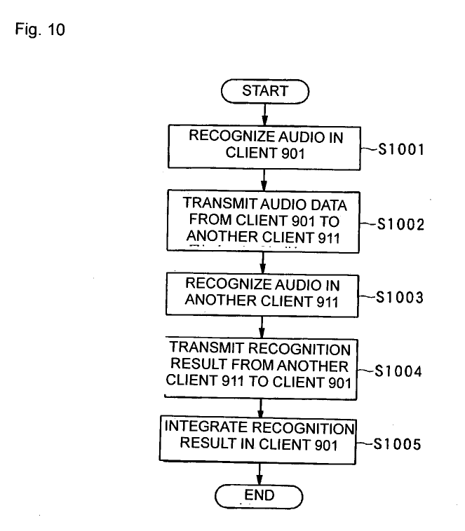

Description will be made of a voice recognition system according to a second embodiment of the present invention. FIG. 9 shows a whole structure of the voice recognition system according to the second embodiment of the present invention. FIG. 10 is a flowchart of operations of the voice recognition system shown in FIG. 9.

This embodiment is different from the first embodiment in that recognition is performed using another client 911 in stead of the server 111 shown in FIG. 1.

In other words, the voice recognition system according to this embodiment comprises a plurality of clients connected to each other by network. Thus, the respective clients take partial charge of different vocabulary and distributed recognition is performed in parallel, so that they can process large vocabulary which can not processed by one client.

Here, as the clients 901 and 911 according to this embodiment, as described above there are a personal computer, a PDA, a mobile phone, a car navigation system, a mobile personal computer or the like. However, the client according to the present invention is not limited to those and other kind of clients can be used.

According to this embodiment, as shown in FIG. 6, the voice recognition system of this embodiment comprises two clients, but the client may be three or more.

In case the mobile phone or the PDA is used as the clients 901 and 911 according to this embodiment, the structures thereof are the same as that described with reference to FIGS. 2 and 3 in the voice recognition system according to the first embodiment of the present invention.

Therefore, when the mobile phone shown in FIG. 2 is used as the client to which audio data is transmitted from another client in this embodiment, functions of audio receiving means, second audio recognition means, second transmitting means described in claims of the present invention are implemented by the CPU 201 shown in FIG. 2 alone or such that it collaborates with other parts shown in FIG. 2 or the program stored in the EEPROM 202.

Similarly, when the PDA shown in FIG. 3 is used as the client to which audio data is transmitted from another client in this embodiment, functions of audio receiving means, second audio recognition means, second transmitting means described in claims of the present invention are implemented by the CPU 301 shown in FIG. 3 alone or such that it collaborates with other parts shown in FIG. 3 or the program stored in the ROM 308 or the storage medium 310.

Hereinafter operations according to this embodiment will be described with reference to FIGS. 9 and 10. Referring to FIG. 9, the client 901 is a terminal owned by a user and has a function of communicating with other one or more clients.

The client 901 recognizes audio given from the user at step S1001. In addition, the client 901 transmits the audio data to other one or more clients at step S1002.

When the client receives the audio data, the client recognizes the audio data at step S1003 and transmits the recognition result to the client of the audio data source at step S1004.

The client 901 receives the recognition result of the audio data, integrates the recognition results and outputs it at step S1005.

The other client 911 which is the destination of the audio data may be previously set by the user or may be determined when the audio is input.

As a method of determining the destination, there is a method of transmitting the data to a server which exists close to the source client in view of a physical distance. That is, the server to communicate with may be determined according to the information referring to a distance between the devices.

The information referring to the distance can comprise positional information of the base station with which the client communicates or information obtained by using GPS (Global Positioning Systems).

Then, a function structure of the client 901 will be described. An audio input part 902 receives audio from the user.

In addition, the audio input part 902 outputs the audio data to an audio recognition engine 904 and an audio transmit part 905.

Furthermore, the audio input part 902 converts analog input audio to digital audio data.

A recognition dictionary 903 stores vocabulary. The user or a designer previously registers the vocabulary in the recognition dictionary 903. In addition, the recognition dictionary 903 outputs the vocabulary to the audio recognition engine 904.

Then, the audio recognition engine 904 loads the vocabulary from the recognition dictionary 903. Furthermore, the audio recognition engine 904 receives the audio data from the audio input part 902.

Still further, the audio recognition engine 904 recognizes the audio data based on the vocabulary and the recognition result is output to a result integration part 906.

Here, the structure and operations of the audio recognition engine 904 according to this embodiment may be the same as those of the above-described audio recognition engine 104 or may be different from those.

Furthermore, the outline of the recognition result of the audio by the audio recognition engine 904 is the same as the above-described recognition result shown in FIG. 4.

The audio recognition engine 904 rejects the recognition result when the degree of reliability of the recognition result is lower than a threshold value and outputs the information that it is rejected to the audio transmit part 905 and the result integration part 906.

Then, the audio transmit part 905 receives the audio data from the audio input part 902. In addition, the audio transmit part 905 transmits the audio data to another client when the recognition result input from the audio recognition engine 904 is rejected.

Then, the result integration part 906 receives the recognition result from the audio recognition engine 904 and also receives the recognition result from the other client 911.

Furthermore, the result integration part 906 outputs an integrated recognition result. The output by the result integration part 906 is used for confirmation by the audio or application.

The result integration part 906 integrates the recognition result of each client. The result integration part 906 employs the result having the largest degree of reliability among the recognition results, for example.

Then, the client 911 has a function of communicating with the other one or more client at a terminal owned by the user.

Then, the client 911 recognizes the audio data received from the other client 901. The recognition result is returned to the source client. Hereinafter, operations of the client 911 will be described.

First, the audio input part 912 receives audio data from the other client (client 901).

Then, the audio input part 912 outputs the audio data received from the other client to the audio recognition engine 914.

Then, the user or designer previously registers vocabulary in the recognition dictionary 913. In addition, the recognition dictionary 913 outputs the vocabulary to the audio recognition engine 914.

Then, the audio recognition engine 914 loads the vocabulary from the recognition dictionary 913. Furthermore, the audio recognition engine 914 receives the audio data from the audio input part 912.

Then, the audio recognition engine 914 recognizes the audio data based on the vocabulary and outputs the recognition result to the result integration part 916.

Furthermore, the audio recognition engine 914 rejects the recognition result when the degree of reliability of the recognition result is lower than a threshold value and outputs the information that it is rejected to the result integration part 916.

Here, the structure and operations of the audio recognition engine 914 according to this embodiment may be the same as those of the above-described audio recognition engine 104 in the voice recognition system of the first embodiment of the present invention, or may be different from those.

Furthermore, the outline of the recognition result of the audio by the audio recognition engine 914 is the same as the above-described recognition result shown in FIG. 4.

Then, since the audio transmit part 915 in the client 911 has a role to receive and recognize the audio data from the client 901, it is not used.

Then, the result integration part 916 transmits the recognition result obtained from the audio recognition engine 914 to the client 901 of the audio data source.

Thus, according to the voice recognition system of the second embodiment of the present invention, even if the server 111 is not particularly prepared as in the embodiment 1, since the role to recognize the audio is shared by the clients connected to each other, audio recognition above the audio recognition capability of each client can be performed.

As described above, according to the present invention, since the audio data input to one device is recognized by another device connected to that device by transmission, even if the vocabulary used by each user is different, the audio recognition can be performed about the vocabulary more than that can be processed by one device.

Furthermore, since the recognition dictionary is updated according to the number of recognitions, even if the user does not manually updates the recognition dictionary, the appropriate recognition dictionary can be provided.

What is claimed is:

1. A voice recognition system consisting of a plurality of devices among which at least one or more devices comprises:
audio input means to which audio data is input;
first audio recognition means for recognizing said audio data;
first transmitting means for transmitting said audio data to another device in a predetermined case;
receiving means for receiving a recognition result of said audio from the destination device of said audio data; and
result integration means for outputting a recognition result of the audio according to at least one of a recognition result in said first audio recognition means and the recognition result received by said receiving means, and among which at least one or more devices comprises:
audio receiving means for receiving said audio data from the device to which said audio data was input;
second audio recognition means for recognizing said audio data; and
second transmitting means for transmitting a recognition result of said second audio recognition means to the destination device of said audio data.

2. A voice recognition system according to claim 1, wherein a predetermined case said first transmitting means transmits said audio data to another device is a case a degree of reliability in the recognition result by said first audio recognition means is not more than a predetermined threshold value.

3. A voice recognition system according to claim 1 or 2, wherein at least one or more devices among said plurality of devices comprises storing means for storing vocabulary and updating means for updating the vocabulary stored in said storing means, and said updating means receives information referring to vocabulary from at least one or more other devices and updates the vocabulary stored in said storing means.

4. A voice recognition system according to any one of claim 1 to 3, wherein at least one or more devices among said plurality of devices starts connection to at least one or more other devices on a condition that a predetermined event occurs.

5. A device in a voice recognition system consisting of a plurality of devices, comprising:
audio input means to which audio data is input;
first audio recognition means for recognizing said audio data;
first transmitting means for transmitting said audio data to another device in a predetermined case;
receiving means for receiving a recognition result of said audio from the destination device of said audio data; and
result integration means for outputting a recognition result of the audio according to at least one of a recognition result in said first audio recognition means and the recognition result received by said receiving means, and
at least one or more second devices among said plurality of devices comprising:
audio receiving means for receiving said audio data from the device to which said audio data was input;
second audio recognition means for recognizing said audio data; and
second transmitting means for transmitting a recognition result of said second audio recognition means to the destination device of said audio data.

6. A device according to claim 5, wherein a predetermined case said first transmitting means transmits said audio data to another device is a case a degree of reliability in the recognition result by said first audio recognition means is not more than a predetermined threshold value.

7. A device according to claim 5 or 6, comprising storing means for storing vocabulary and updating means for updating the vocabulary stored in said storing means, and said updating means receives information referring to vocabulary from at least one or more other devices and updates the vocabulary stored in said storing means.

8. A device according to any one of claims 5 to 7, which starts connection to at least one or more other devices on a condition that a predetermined event occurs.

9. A device in a voice recognition system consisting of a plurality of devices, comprising audio receiving means for receiving said audio data;
second audio recognition means for recognizing said audio data; and
second transmitting means for transmitting a recognition result of said second audio recognition means to the destination device of said audio data, from a first device comprising:
audio input means to which audio data is input;
first audio recognition means for recognizing said audio data;
first transmitting means for transmitting said audio data to another device in a predetermined case;
receiving means for receiving a recognition result of said audio from the destination device of said audio data; and
result integration means for outputting a recognition result of the audio according to at least one of a recognition result in said first audio recognition means and the recognition result received by said receiving means.

10. A device according to claim 9, wherein a predetermined case said first transmitting means transmits said audio data to another device is a case a degree of reliability in the recognition result by said first audio recognition means is not more than a predetermined threshold value.

11. A method of recognizing audio in a device in a voice recognition system consisting of a plurality of devices comprising:
an input step of inputting audio data;
a device to which said audio data is input comprising steps of:
a first audio recognition step of recognizing said audio data;
a first transmitting step of transmitting said audio data to another device in a predetermined case;
a receiving step of receiving a recognition result of said audio from the destination device of said audio data; and
a result integration step of outputting the recognition result of the audio according to at least one of the recognition result in said first audio recognition step and the recognition result received in said receiving step,
a device among said plurality of devices comprising:
an audio receiving step of receiving said audio data from the device to which said audio data is input;
a second audio recognition step of recognizing said audio data; and
a second transmitting step of transmitting the recognition result of said second audio recognition step to the designation device of said audio data.

12. A method of recognizing audio according to claim 11, wherein a predetermined case said audio data is transmitted to another device at said first transmitting step is a case a degree of reliability in the recognition result by said first audio recognition step is not more than a predetermined threshold value.

13. A method of recognizing audio according to claim 11 or 12, wherein a device among said plurality of devices comprises storing step of storing vocabulary and updating step of updating said stored vocabulary, and said updating step receives information referring to vocabulary from at least one or more other devices and updates the stored vocabulary.

14. A method of recognizing audio according to any one of claims 11 to 13, wherein at least one or more devices among said plurality of devices starts connection to at least one or more other devices on a condition that a predetermined event occurs.

15. A voice recognition program for making a device in a voice recognition system consisting of a plurality of devices function as:
audio inputting means to which audio data is input;
first audio recognition means for recognizing said audio data;
first transmitting means for transmitting said audio data to another device in a predetermined case;
receiving means for receiving a recognition result of said audio from the destination device of said audio data; and
result integration means for outputting the recognition result of the audio according to at least one of the recognition result in said first audio recognition means and the recognition result received by said receiving means.

16. A voice recognition program according to claim 15, wherein a predetermined case said first transmitting means transmits said audio data to another device is a case a degree of reliability in the recognition result by said first audio recognition means is not more than a predetermined threshold value.

17. A voice recognition program according to claim 15 or 16, comprising a step of functioning as updating means for updating vocabulary stored in storing means for storing the vocabulary, and
said updating means receives information referring to vocabulary from at least one or more other devices and updates the vocabulary stored in said storing means.

18. A voice recognition program according to any one of claims 15 to 17, wherein a connection between devices starts on a condition that a predetermined event occurs.

19. A voice recognition program in a device in a voice recognition system consisting of a plurality of devices whose first device comprises:
audio input means to which audio data is input;
first audio recognition means for recognizing said audio data;
first transmitting means for transmitting said audio data to another device in a predetermined case;
receiving means for receiving a recognition result of said audio from the destination device of said audio data; and
result integration means for outputting a recognition result of the audio according to at least one of a recognition result in said first audio recognition means and the recognition result received by said receiving means, and
a device in said audio recognition system which receives said audio data from said first device functioning as:
audio receiving means for receiving said audio data;
second audio recognition means for recognizing said audio data; and
second transmitting means for transmitting a recognition result by said second audio recognition means to the destination device of said audio data.

20. A voice recognition program according to claim 19, wherein a predetermined case said first transmitting means transmits said audio data to another device is a case a degree of reliability in the recognition result by said first audio recognition means is not more than a predetermined threshold value.
